(19) United States
(12) Patent Application Publication
(10) Pub. No.: US 2025/0284438 A1
(43) Pub. Date: Sep. 11, 2025

(54) INFORMATION PROCESSING APPARATUS, INFORMATION PROCESSING METHOD, AND STORAGE MEDIUM

(71) Applicant: SEIKO EPSON CORPORATION, TOKYO (JP)

(72) Inventor: Koki NOMURA, AZUMINO-SHI (JP)

(21) Appl. No.: 19/070,710

(22) Filed: Mar. 5, 2025

(30) Foreign Application Priority Data
Mar. 5, 2024 (JP) 2024-032765

(51) Int. Cl. G06F 3/12; G06K 15/02

(52) U.S. Cl. CPC G06F 3/1205; G06F 3/1253; G06K 15/1807

(57) ABSTRACT

An image shape information storage stores a plurality of pieces of image shape information each indicating image shapes different from each other of a print image to be printed on a medium. A correspondence information storage stores correspondence information associating a plurality of pieces of type information with the plurality of pieces of image shape information. A print image data receiver acquires print image data to be set in a print job. By referring to the correspondence information, a type selector selects, from the plurality of pieces of type information, type information corresponding to the image shape information of the print image data acquired by the print image data receiver. An action executor executes at least one action based on the type information selected by the type selector.

The present application is based on, and claims

priority from JP Application Serial Number 2024-032765, filed Mar. 5, 2024, the disclosure of which is hereby incorporated by reference herein in its entirety.

### BACKGROUND

### 1. Technical Field

The present disclosure relates to an information processing apparatus, an information processing method, and a storage medium.

### 2. Related Art

JP-A-2022-159645 discloses a flatbed printer as a

printing apparatus that prints an image mainly on three-dimensional media or thick media. In the flatbed printer, for example, a relatively large medium, such as a panel or signboard made of acrylic or wood, or a relatively small medium, such as a coaster, is mounted on a mounting table. An image is printed on the mounted medium by an ink jet method.

In the flatbed printer, precut media are placed on the mounting table to match a printing position. The printing position is set, for example, using software such as a printing application. Raster image processor (RIP) software is used particularly in the commercial printing field.

It is known that a flatbed printer performs printing on media made of various materials and having various shapes. With an increasing number of media types to be usable, for setting a media type on the RIP software, it is required to search for and select an appropriate media type from an enormous number of media types displayed in a list. At this point, however, a different media type from the media type on which printing is to be performed may be selected.

### SUMMARY

According to an aspect of the present disclosure, there

is provided an information processing apparatus including a type information storage storing a plurality of pieces of type information each indicating types of medium different from each other, an image shape information storage storing a plurality of pieces of image shape information each indicating image shapes different from each other of a print image to be printed on the medium, a correspondence information storage storing correspondence information associating the plurality of pieces of type information with the plurality of pieces of image shape information, a print image data acquirer configured to acquire print image data to be set in a print job, a type selector configured to, by referring to the correspondence information, select, from the plurality of pieces of type information, type information corresponding to the image shape information of the print image data acquired by the print image data acquirer; and an action executor configured to execute at least one action based on the type information selected by the type selector.

According to an aspect of the present disclosure, there is provided an information processing method executed by a computer, including storing a plurality of pieces of type information each indicating types of medium different from each other; storing a plurality of pieces of image shape information each indicating image shapes different from each other of a print image to be printed on the medium; storing correspondence information associating the plurality of pieces of type information with the plurality of pieces of image shape information; acquiring print image data to be set in a print job; selecting, by referring to the correspondence information, from the plurality of type information, type information corresponding to the image shape information of the acquired print image data; and executing at least one action based on the selected type information.

According to an aspect of the present disclosure, there is provided a non-transitory computer-readable storage medium storing a program that causes a computer to function as: a type information storage storing a plurality of pieces of type information each indicating types of medium different from each other; an image shape information storage storing a plurality of pieces of image shape information each indicating image shapes different from each other of a print image to be printed on the medium; a correspondence information storage storing correspondence information associating the plurality of pieces of type information with the plurality of pieces of image shape information; a print image data acquirer configured to acquire print image data to be set in a print job; a type selector configured to, by referring to the correspondence information, select, from the plurality of pieces of type information, type information corresponding to the image shape information of the print image data acquired by the print image data acquirer; and an action executor configured to execute at least one action based on the type information selected by the type selector.

### BRIEF DESCRIPTION OF THE DRAWINGS

FIG. 1 is a block diagram of a printing system.

FIG. 2 is a data structure table of correspondence information.

FIG. 3 shows a GUI of RIP software.

FIG. 4 is a control flow when the GUI is displayed.

FIG. 5 is a control flow when a print image input button has been clicked.

FIG. 6 is a control flow when the print image input button has been clicked.

FIG. 7 is a control flow when a registration button has been clicked.

### DESCRIPTION OF EMBODIMENTS

The present disclosure will be described through embodiments hereafter; however, the description is not intended to limit the disclosure according to the appended claims to the following embodiments. In addition, all of the configurations described in the embodiments are not necessarily essential as measures for solving the problems. To achieve clarification, the following description and drawings are appropriately omitted and simplified. In the drawings, the same elements are denoted by the same reference numerals, and redundant description thereof will be omitted as appropriate.

### Overview of Printing System 1

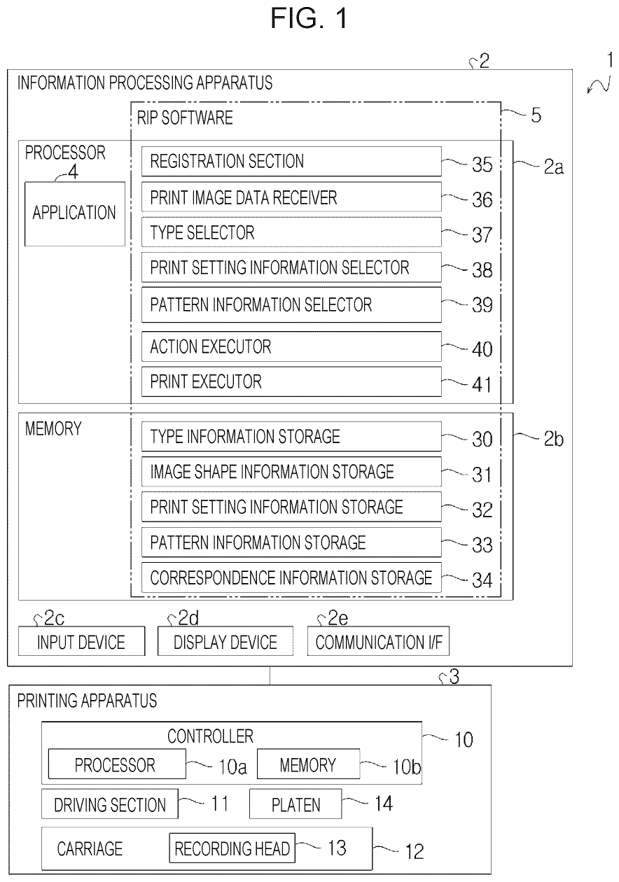

FIG. 1 shows a block diagram of a printing system 1. As shown in FIG. 1, the printing system 1 includes an information processing apparatus 2 and a printing apparatus 3. The information processing apparatus 2 is typically a personal computer. The printing apparatus 3 is a flatbed printer.

The information processing apparatus 2 includes a processor 2a, a memory 2b, an input device 2c, a display device 2d, and a communication interface (I/F) 2e. The information processing apparatus 2 communicates with the printing apparatus 3 via the communication I/F 2e. The processor 2a is capable of accessing the memory 2b. The processor 2a reads and executes a program stored in the memory 2b. Accordingly, the program causes hardware such as the processor 2a to execute the functions of an application 4 and raster image processor (RIP) software 5. In the following description, the execution of functions of the RIP software 5 by the processor 2a may be expressed simply as execution of the RIP software 5.

The input device 2c is a measure for receiving a user operation. The input device 2c is typically implemented by a keyboard or a pointing device.

The display device 2d is a measure for displaying visual information. The display device 2d is typically implemented by a liquid crystal display (LCD) or an organic light emitting diode (OLED).

The application 4 generates print image data representing a print image, which is a pattern to be printed on a medium in accordance with a drawing instruction from a user.

The medium on which printing is performed by the printing apparatus 3 has a certain thickness, and non-limiting examples of the typical medium include a smartphone case, a badge, and a key ring. Such a medium is also referred to as a product material or media in some cases. For example, even only regarding smartphone cases, there are an enormous number of types of smartphone cases. Additionally, the material may differ when the type of medium differs. In such a case, it is necessary that print setting parameters, which are used for performing printing by the printing apparatus 3, differ.

The RIP software 5 generates first print control data based on the print image data, and transmits the generated first print control data to the printing apparatus 3. The first print control data is data for the printing apparatus 3 to print the print image data. Additionally, the RIP software 5 generates second print control data based on pattern information indicating a positioning pattern for arranging a medium at an appropriate position in the printing apparatus 3, and transmits the generated second print control data to the printing apparatus 3. The second print control data is data for the printing apparatus 3 to print the positioning pattern. The RIP software 5 is also referred to as a printer driver. Details of the RIP software 5 will be described later.

The medium on which the positioning pattern is printed is typically a paper sheet. Therefore, the paper sheet on which the positioning pattern is printed is hereafter also referred to as a positioning sheet. The positioning sheet is a specific example of a positioning medium.

The printing apparatus 3 includes a controller 10, a driving section 11, a carriage 12, a recording head 13, a platen 14, and an ultraviolet (UV) irradiator (not shown).

The controller 10 includes a processor 10a and a memory 10b. The processor 10a performs processing according to predetermined firmware stored in the memory 10b.

The platen 14 is typically a flat plate in a horizontal orientation. A plurality of media are arranged on the platen 14 when printing is simultaneously performed on the plurality of media. Therefore, the platen 14 may be said to support a plurality of media. In simultaneously performing printing on a plurality of media, typically, a positioning sheet is set on the platen 14, and the plurality of media are positioned relative to the platen 14 using a positioning pattern printed on the positioning sheet. Additionally, in the present embodiment, a heater is provided on the platen in order to promote drying of ink, and the platen temperature can be adjusted by using the heater.

The recording head 13 performs recording by ejecting a liquid such as ink according to an ink jet method. The recording head 13 including a plurality of nozzles ejects ink onto a plurality of media or paper sheets arranged on the platen 14. The controller 10 permits or inhibits the ejection of ink from the plurality of nozzles by controlling the recording head 13 with a predetermined ejection waveform based on the first print control data or the second print control data received from the information processing apparatus 2. As a result, the recording head 13 applies ink at a desired ink density onto the medium. Additionally, the ink applied onto the medium forms an ink layer, and the number of ink layers may be plural.

The carriage 12 and the driving section 11 move the recording head 13 relative to the platen 14 and the medium. The carriage 12, on which the recording head 13 is mounted, reciprocates the recording head 13 in the main scanning direction relative to the platen 14 and the medium. The speed of this reciprocating movement is referred to as a head speed. Additionally, the driving section 11 moves the recording head 13 in a sub-scanning direction intersecting the main scanning direction relative to the platen 14 and the medium. Further, the driving section 11 causes the distance between the platen 14 and the nozzles of the recording head 13 to vary in the vertical direction intersecting the main scanning direction and the sub-scanning direction. This distance is also referred to as the platen gap. The controller 10 causes the scanning speed, which is the movement speed of the carriage 12, and the size of the platen gap to vary in accordance with print setting parameters described later.

The UV irradiator, which is, for example, mounted on the carriage 12, is moved in the main scanning direction relative to the platen 14 and the medium in the same manner as the recording head 13. At this time, the ink on the medium is irradiated with ultraviolet rays. As a result, the ink on the medium is solidified or cured. In accordance with print setting parameters described later, the controller 10 changes the UV irradiation intensity and the UV exposure count in UV irradiation performed by the UV irradiator.

### Details of RIP Software 5

By executing the program of the RIP software 5, the processor 2a functions as a registration section 35, a print image data receiver 36, a type selector 37, a print setting information selector 38, a pattern information selector 39, an action executor 40, and a print executor 41. Additionally, by storing various kinds of information according to the program of the RIP software 5, the memory 2b functions as a type information storage 30, an image shape information storage 31, a print setting information storage 32, a pattern information storage 33, and a correspondence information storage 34.

The type information storage 30 stores a plurality of pieces of type information. The plurality of pieces of type information each indicate a plurality of types of medium different from each other. Each piece of type information typically includes an identification character string identifying the corresponding type. The identification character string identifying the type is hereafter also referred to as a type identification character string.

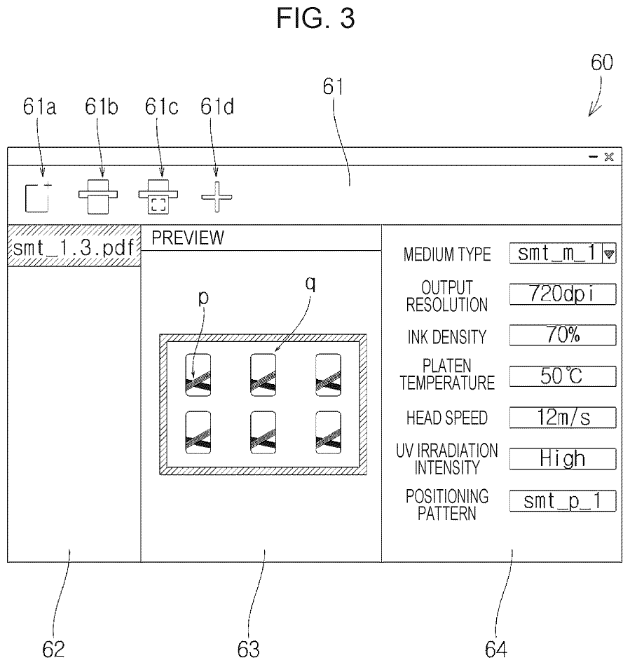

The image shape information storage 31 stores a plurality of pieces of image shape information. The plurality of pieces of image shape information each indicate image shapes different from each other of a print image to be printed on a medium. Here, the image shape typically refers to the horizontal and vertical dimensions that are dimensional parameters of a print image, that is, the horizontal dimension and the vertical dimension. However, instead of this, the image shape may refer to a ratio between the horizontal dimension and the vertical dimension of the print image, and is not limited to the dimensions and may be an outer shape. The outer shape as used herein is, for example, a quadrangle with curved corners, that is, an outer shape of a smartphone case as shown in FIG. 3; however, the outer shape is changed appropriately in accordance with the type of medium such as a badge or a key ring. In the present embodiment, the image shape refers to the horizontal dimension and the vertical dimension of the print image. The identification character string identifying the image shape is hereafter also referred to as an image shape identification character string. Each piece of image shape information includes an image shape identification character string, which identifies a corresponding image shape, and dimension parameters.

A print image is input as print image data to the RIP software 5. The print image is typically created by loading a template image suitable for a medium into the application 4 and processing the template image. Therefore, the horizontal dimension and the vertical dimension of the print image match the horizontal dimension and the vertical dimension of the template image used to create the print image. The template image is made up of outlines indicating a region in which the print image is to be arranged. Examples of the outline typically include a bleed line, a cut line, and a print safe line. The horizontal dimension and the vertical dimension of the template image typically correspond to the horizontal dimension and the vertical dimension of a rectangle defined by the bleed line. Additionally, the term “dimension” typically refers to a physical dimension obtained by actually measuring a print image printed on a paper sheet, as expressed in millimeters or inches.

In general, a template image is provided by a dealer who sells a medium on the assumption that printing will be later performed thereon. For example, a dealer who sells a smartphone case as a medium sells a plain smartphone case, on which a pattern, for example, is not printed, and also provides a template image corresponding to the type of smartphone case to a purchaser of the smartphone case who is also the user of the printing apparatus 3. Using the application 4, the user processes the template image obtained from the dealer to create a print image. More specifically, using the application 4, the user edits the template image and arranges a desired pattern in accordance with the outline, thereby creating a print image. For example, at this time, the user may add an image layer in which a desired pattern is arranged, as a different image layer, to the image layer including the outline of the template image, and may use the resultant image layer as the print image. In any case, since the user does not need to change the horizontal dimension and vertical dimension of the template image when creating a print image, the horizontal dimension and the vertical dimension of the created print image match the horizontal dimension and the vertical dimension of the template image, respectively.

The print setting information storage 32 stores a plurality of pieces of print setting information. The plurality of pieces of print setting information each indicate a plurality of print settings different from each other. Each piece of print setting information typically includes a plurality of print setting parameters. The plurality of print setting parameters are illustrated below. Some of the plurality of print setting parameters illustrated below may be omitted. Each piece of print setting information includes an identification character string identifying the corresponding print setting, and a plurality of print setting parameters. The identification character string identifying the print setting is hereafter also referred to as a print setting identification character string.
Parameters related to a printing method (output resolution, ink density, platen temperature, platen gap, head speed, ejection waveform, number of ink layers)
Parameter related to a positioning pattern
UV irradiation mode (UV irradiation intensity, UV exposure count)
Print image adjustment (input resolution for RIP characters, enlargement/reduction ratio, the number of copies, image rotation direction, image arrangement position):
Parameters related to color settings (input profile, output profile, rendering intent, color correction (black point correction, pure color retention), color replacement settings)

In addition, a parameter related to printing of a mark for shredding a medium, a parameter for use when information related to a print job is printed as a header, a footer, or another element, a parameter for use when a base layer or a top coat is printed, and so on may be included as the print setting parameters.

The pattern information storage 33 stores a plurality of pieces of pattern information. The plurality of pieces of pattern information each indicate a plurality of positioning patterns different from each other. Each piece of pattern information may include the image information of a corresponding positioning pattern. In this case, each piece of pattern information includes an identification character string identifying the corresponding positioning pattern, and the image information. When the corresponding positioning pattern is a grid line that supports positioning of the corresponding medium, each piece of pattern information may include dimension parameters of the grid line. In this case, each piece of pattern information includes an identification character string identifying a corresponding positioning pattern, and the dimension parameters. The identification character string identifying the positioning pattern is hereafter also referred to as a pattern identification character string.

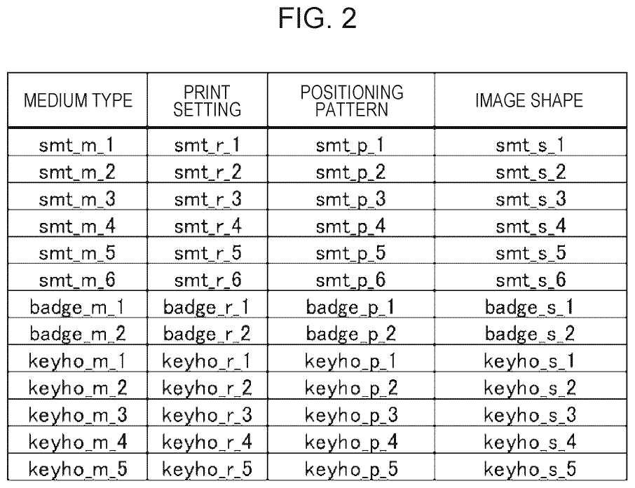

The correspondence information storage 34 associates the plurality of pieces of type information, the plurality of pieces of print setting information, the plurality of pieces of pattern information, and the plurality of pieces of image shape information with one another. FIG. 2 shows a data structure table of correspondence information. In FIG. 2, “medium type” corresponds to the type information. Character strings such as “smt_m_1”, “smt_m_2”, and “keyho_m_1” indicated in “medium type” are type identification character strings of the corresponding pieces of type information. “Print setting” corresponds to print setting information. Character strings such as “smt_r_1”, “smt_r_2”, and “keyho_r_1” indicated in “print setting” are print setting identification character strings of the corresponding pieces of print setting information. “Positioning pattern” corresponds to pattern information. Character strings such as “smt_p_1”, “smt_p_2”, and “keyho_p_1” indicated in “positioning pattern” are pattern identification character strings of the corresponding pieces of pattern information. “Image shape” corresponds to the image shape information. Character strings such as “smt_s_1”, “smt_s_2”, and “keyho_s_1” indicated in “image shape” are image shape identification character strings of the corresponding pieces of image shape information.

In FIG. 2, all of “smt_m_1” to “smt_m_6” are type identification character strings related to smartphone cases. Both “badge_m_1” and “badge_m_2” are type identification character strings related to badges. Any of “keyho_m_1” to “keyho_m_5” is a type identification character string related to a key ring.

In the present embodiment, as shown in FIG. 2, the correspondence information associates one piece of type information with one piece of print setting information, one piece of pattern information, and one piece of image shape information on a one-to-one basis. However, instead of this, a plurality of pieces of print setting information, a plurality of pieces of pattern information, and a plurality of pieces of image shape information may be associated with one piece of type information on a one-to-many basis.

The registration section 35 registers a new correspondence relationship in the correspondence information of the correspondence information storage 34. Specifically, the registration section 35 acquires the type information, the image shape information, the print setting information, and the pattern information that correspond to one another. The registration section 35 stores the acquired type information in the type information storage 30. The registration section 35 stores the acquired image shape information in the image shape information storage 31. The registration section 35 stores the acquired print setting information in the print setting information storage 32. The registration section 35 stores the acquired pattern information in the pattern information storage 33. Then, the registration section 35 registers the correspondence relationship among the type information, the image shape information, the print setting information, and the pattern information, which correspond to one another, in the correspondence information in the correspondence information storage 34.

The print image data receiver 36 receives print image data via a user input. Thus, the print image data receiver 36 acquires the print image data. The print image data receiver 36 is a specific example of a print image data acquirer.

By referring to the correspondence information, the type selector 37 selects, from the plurality of pieces of type information, type information corresponding to the image shape information of the print image data acquired by the print image data receiver 36. The details are as follows.

First, the type selector 37 acquires image shape information of print image data by analyzing the print image data. Then, by referring to the correspondence information shown in FIG. 2, the type selector 37 compares the image shape information with a plurality of pieces of image shape information registered in the correspondence information. Then, when image shape information that matches the image shape information of interest is registered in the correspondence information, the type selector 37 acquires type information corresponding to the image shape information that matches the image shape information of interest. Details of the type selector 37 will be described later.

By referring to the correspondence information, the print setting information selector 38 selects print setting information corresponding to the type information selected by the type selector 37 from a plurality of pieces of print setting information.

By referring to the correspondence information, the pattern information selector 39 selects, from a plurality of pieces of pattern information, pattern information corresponding to the type information selected by the type selector 37.

The action executor 40 executes various actions. For example, the action executor 40 generates a new print job. The action executor 40 then sets, in the print job, the print image data acquired by the print image data receiver 36. Additionally, the action executor 40 sets, in the print job, the type information selected by the type selector 37, the print setting information selected by the print setting information selector 38, and the pattern information selected by the pattern information selector 39.

Hereafter, a graphical user interface (GUI) 60 of the RIP software 5 displayed on the display device 2d by the action executor 40 will be described with reference to FIG. 3. The GUI 60 includes a tool bar 61, a file name list box 62, a preview box 63, and a print job panel 64. FIG. 3 exemplarily shows the GUI 60 when printing is performed simultaneously on six smartphone cases.

The action executor 40 displays, in a clickable button format on the tool bar 61, a print image input button 61a for inputting print image data, a print image print button 61b, a positioning pattern print button 61c, and a registration button 61d for registering a new correspondence relationship into the correspondence information in the correspondence information storage 34.

The action executor 40 displays, in the file name list box 62, the file name of print image data, which has been loaded into the RIP software 5 by the user. In other words, the action executor 40 displays, in the file name list box 62, the file name of the print image data set in the print job.

The action executor 40 displays, in the preview box 63, a print image p indicated by the print image data acquired by the print image data receiver 36 and a pattern image q indicated by the pattern information selected by the pattern information selector 39 in a superimposed manner.

The action executor 40 displays print job settings on the print job panel 64. The print job settings include at least type information, print setting information, and pattern information. That is, the action executor 40 displays the type identification character string of the type information selected by the type selector 37, the plurality of print settings indicated by the print setting information selected by the print setting information selector 38, and the pattern identification character string of the pattern information selected by the pattern information selector 39 together. In the example shown in FIG. 3, in the print job, “smt_m_1” is set as the type information, and “smt_p_1” is set as the pattern information. Additionally, the output resolution, the ink density, the platen temperature, the head speed, the UV irradiation intensity, and so on are set as print setting information of the print job.

The print executor 41 executes a print job. Specifically, when the print image print button 61b is clicked, the print executor 41 converts the print image data set in the print job into the first print control data and transmits the first print control data to the printing apparatus 3. As a result, the printing apparatus 3 performs printing based on the first print control data. Additionally, when the positioning pattern print button 61c is clicked, the print executor 41 generates second print control data based on the pattern information set in the print job and transmits the generated second print control data to the printing apparatus 3. Thus, the printing apparatus 3 performs printing based on the second print control data.

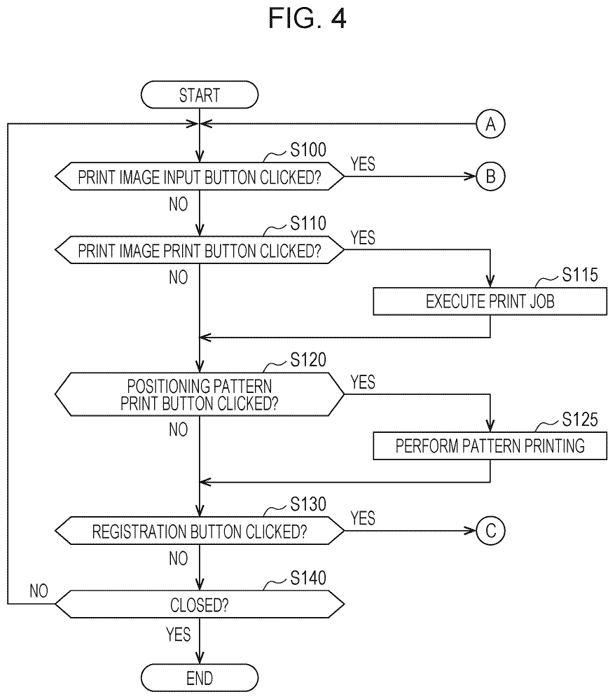

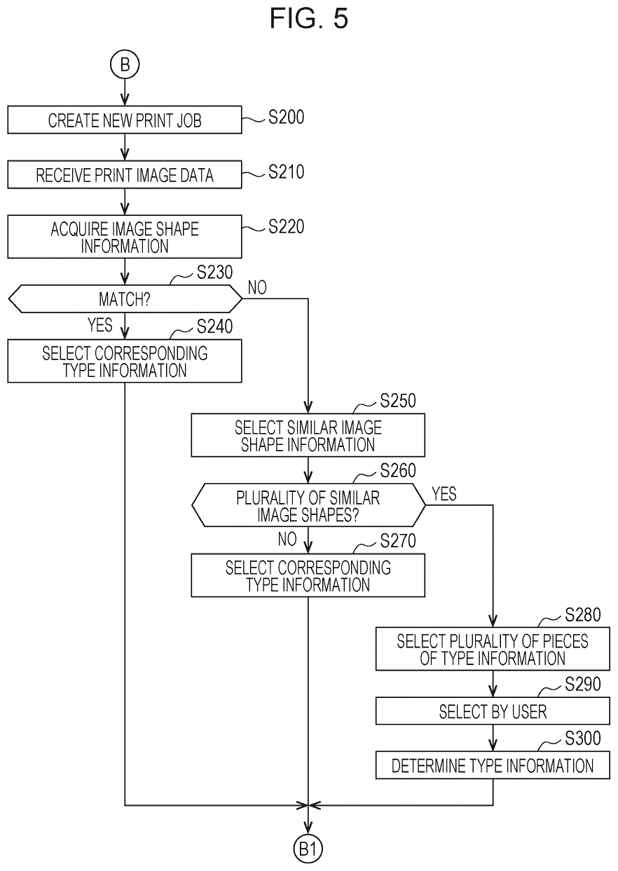

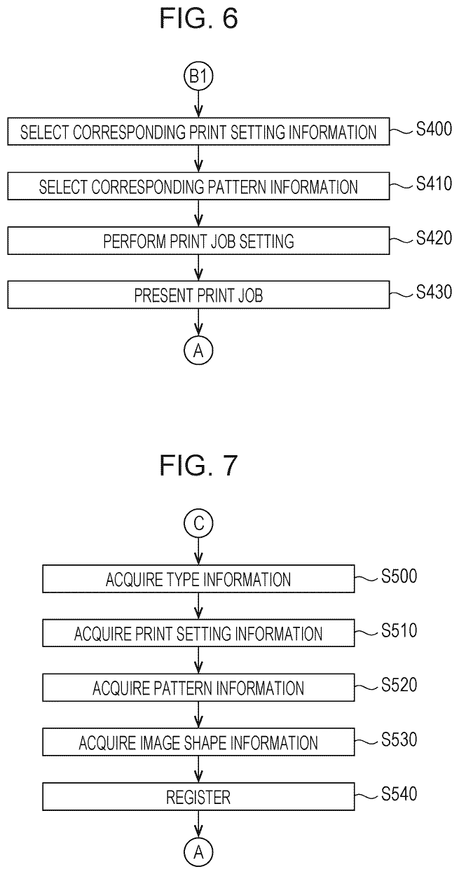

The control flow of the RIP software 5 will be described with reference to FIGS. 4 to 7. FIG. 4 is a control flow when the GUI 60 is displayed. FIGS. 5 and 6 are control flows when the print image input button 61a has been clicked. FIG. 7 is a control flow when the registration button 61d has been clicked.

As shown in FIG. 4, the RIP software 5 determines whether the print image input button 61a has been clicked (S100). When it is determined that the print image input button 61a has been clicked (S100: YES), the RIP software 5 causes the process to proceed to step S200 in FIG. 5. When it is determined that the print image input button 61a has not been clicked (S100: NO), the RIP software 5 causes the process to proceed to step S110.

The RIP software 5 determines whether the print image print button 61b has been clicked (S110). When it is determined that the print image print button 61b has been clicked (S110: YES), the print executor 41 of the RIP software 5 executes the print job (S115) and causes the process to proceed to S120. When it is determined that the print image print button 61b has not been clicked (S110: NO), the RIP software 5 causes the process to proceed to S120.

The RIP software 5 determines whether the positioning pattern print button 61c has been clicked (S120). When it is determined that the positioning pattern print button 61c has been clicked (S120: YES), the print executor 41 of the RIP software 5 generates the second print control data based on the pattern information set in the print job, transmits the generated second print control data to the printing apparatus 3 (S125), and causes the process to proceed to S130. When it is determined that the positioning pattern print button 61c has not been clicked (S120: NO), the RIP software 5 causes the process to proceed to S130.

The RIP software 5 determines whether the registration button 61d has been clicked (S130). When it is determined that the registration button 61d has been clicked (S130: YES), the RIP software 5 causes the process to proceed to step S500 in FIG. 7. When it is determined that the registration button 61d has not been clicked (S130: NO), the RIP software 5 causes the process to proceed to step S140.

The RIP software 5 determines whether GUI 60 has been closed (S140). When it is determined that the GUI 60 has been closed (S140: YES), the RIP software 5 terminates the process. When it is determined that the GUI60 has not been closed (S140: NO), the RIP software 5 returns the process to step S100. Although, in FIG. 4, steps S100, S120, S130, and S140 are shown in this order for ease of understanding, the order of these steps is not limited to this. Additionally, these four steps may be performed in parallel with each other.

### When Print Image Input Button 61a is Clicked

When the print image input button 61a is clicked as shown in FIG. 4 (S100), the RIP software 5 creates a new print job as shown in FIG. 5 (S200). Then, the print image data receiver 36 displays an open file dialog. Thus, the print image data receiver 36 acquires print image data selected by the user via the open file dialog (S210). The print image data receiver 36 sets the print image data selected by the user, as the print image data, in the print job.

Subsequently, by referring to the correspondence information, the type selector 37 of the RIP software 5 selects, from the plurality of pieces of type information, type information corresponding to the image shape information of the print image data acquired by the print image data receiver 36 (S220 to S300). Specifically, the steps are as follows.

First, the type selector 37 acquires image shape information A of the print image data by analyzing the print image data (S220). Then, by referring to the correspondence information shown in FIG. 2, the type selector 37 compares the image shape information A with a plurality of pieces of image shape information B registered in the correspondence information, and determines whether the image shape information B that matches the image shape information A is registered in the correspondence information (S230). If there is a match (S230: YES), the type selector 37 selects and acquires, from the plurality of pieces of type information, type information corresponding to the image shape information B that matches the image shape information A (S240), and causes the process to proceed to step S400 in FIG. 6. For example, as shown in FIG. 3, the image shape in the present embodiment is the horizontal and vertical dimensions of the print image data displayed with the file name “smt_1.3.pdf” in the file name list box 62.

When there is no match in step S230 (S230: NO), the type selector 37 compares the image shape information A with a plurality of pieces of image shape information B registered in the correspondence information, and selects the image shape information B most similar to the image shape information A (S250).

Specifically, the type selector 37 calculates the Manhattan distance X of the image shape information A and also calculates the respective Manhattan distances Y of the plurality of pieces of image shape information B. The type selector 37 selects, as a first candidate list, at least one piece of image shape information B having the smallest difference from the Manhattan distance X among the plurality of Manhattan distances Y.

Additionally, the type selector 37 calculates the aspect ratio W of the image shape information A and also calculates the respective aspect ratios Z of the plurality of pieces of image shape information B. The type selector 37 selects, as a second candidate list, at least one piece of image shape information B having the smallest difference from the aspect ratio W among the plurality of aspect ratios Z.

Subsequently, the type selector 37 specifies at least one piece of image shape information B selected as the first candidate list and selected as the second candidate list, as the image shape information B most similar to the image shape information A. The type selector 37 determines whether a plurality of pieces of image shape information B have been specified as the image shape information B most similar to the image shape information A (S260). When only one piece of image shape information B has been specified as the image shape information B most similar to the image shape information A (S260: NO), the type selector 37 selects, from the plurality of pieces of type information, type information corresponding to the specified image shape information B (S270).

When a plurality of pieces of image shape information B has been specified as the image shape information B most similar to the image shape information A (S260: YES), the type selector 37, by referring to the correspondence information, selects a plurality of pieces of type information respectively corresponding to the specified plurality of pieces of image shape information B (S280), and presents the selected plurality of pieces of type information, typically in a dialog box format, to the user. When any one of the plurality of pieces of type information is selected by the user (S290), the type selector 37 determines the selected type information as the type information corresponding to the print image data (S300), and causes the process to proceed to step S400 in FIG. 6.

At step S400 in FIG. 6, by referring to the correspondence information, the print setting information selector 38 selects, from the plurality of pieces of print setting information, print setting information corresponding to the type information selected by the type selector 37 (S400). Here, as shown in FIG. 3, the print setting information includes, for example, “output resolution”, “ink density”, “platen temperature”, “head speed”, and “UV irradiation intensity”, and may further include other print settings.

Then, by referring to the correspondence information, the pattern information selector 39 selects, from the plurality of pieces of pattern information, pattern information corresponding to the type information selected by the type selector 37 (S410).

Then, the action executor 40 sets, in the print job, the type information selected by the type selector 37, the print setting information selected by the print setting information selector 38, and the pattern information selected by the pattern information selector 39 (S420).

Then, as shown on the print job panel 64 in FIG. 3, the action executor 40 presents the setting contents of the print job to the user (S430), and causes the process to proceed to S110 in FIG. 4. The setting contents of the print job include “output resolution”, “ink density”, “platen temperature”, “head speed”, and “UV irradiation intensity” as print setting information, and may further include other print settings. When presenting the setting contents of the print job to the user, the action executor 40 may, for example, display each print setting in a pull-down menu format, allowing the user to freely change each of the print settings.

### When Registration Button 61d is Clicked

When the registration button 61d is clicked as shown in FIG. 4, the registration section 35 displays a registration screen in a dialog box format as shown in FIG. 7. The user inputs, via the registration screen, type information, print setting information, pattern information, and image shape information, which correspond to each other. Accordingly, the registration section 35 acquires the type information and stores it in the type information storage 30 (S500), acquires the print setting information and stores it in the print setting information storage 32 (S510), acquires the pattern information and stores it in the pattern information storage 33 (S520), and acquires the image shape information and stores it in the image shape information storage 31 (S530).

The user may input the image shape information onto the registration screen in various ways. For example, the user may directly input numerical values of the horizontal dimension and the vertical dimension on the registration screen. In this case, an input box is displayed on the registration screen, and the user can input numerical values of the horizontal dimension and the vertical dimension to the input box via, for example, a keyboard or a numeric keypad provided as the input device 2c. Instead of this, the user may input the print image data, or the template image data used during creating the print image data, on the registration screen. In this case, the registration section 35 may acquire the horizontal dimension and the vertical dimension of the print image or the template image as the image shape information by analyzing the print image data or the template image data input on the registration screen.

Then, the registration section 35 registers, in the correspondence information, the correspondence relationship among the type information, the print setting information, the pattern information, and the image shape information acquired in steps S500 to S530 (S540), and returns the process to step S140 in FIG. 4.

The preferred embodiments of the present disclosure have been described above. The above embodiments have the following features.

The information processing apparatus 2 includes the type information storage 30, the image shape information storage 31, the correspondence information storage 34, the print image data receiver 36, the type selector 37, and the action executor 40. The type information storage 30 stores a plurality of pieces of type information each indicating types of medium different from each other. The image shape information storage 31 stores a plurality of pieces of image shape information each indicating image shapes different from each other of a print image that is to be printed on the medium. The correspondence information storage 34 stores correspondence information associating the plurality of pieces of type information with the plurality of pieces of image shape information. The print image data receiver 36 (print image data acquirer) acquires print image data to be set in a print job. By referring to the correspondence information, the type selector 37 selects, from the plurality of pieces of type information, type information corresponding to the image shape information of the print image data acquired by the print image data receiver 36. The action executor 40 executes at least one action based on the type information selected by the type selector 37. According to the above configuration, processing is performed in accordance with a type of medium corresponding to print image data, and therefore a mismatch between the print image data and the type of medium may be effectively prevented.

In addition, the image shape information indicates the horizontal and vertical dimensions of a print image or the aspect ratio of the print image. According to the above configuration, the image shape information may be easily acquired by analyzing the print image data.

In addition, the at least one action includes presenting the type information selected by the type selector 37 (S430), or setting, in the print job, the type information selected by the type selector 37 (S420). According to the above configuration, the type of medium corresponding to the print image data is presented or set, and therefore a mismatch between the print image data and the type of medium may be effectively prevented.

In addition, the information processing apparatus 2 further includes the print setting information storage 32 that stores a plurality of pieces of print setting information each indicating print settings to be used for printing on a medium. The correspondence information associates the plurality of pieces of type information, the plurality of pieces of image shape information, and the plurality of pieces of print setting information with one another. The information processing apparatus 2 further includes the print setting information selector 38 that, by referring to the correspondence information, selects, from the plurality of pieces of print setting information, print setting information corresponding to type information selected by the type selector 37. The at least one action includes an action based on the print setting information selected by the print setting information selector 38. According to the above configuration, printing is performed in accordance with the type of medium corresponding to the print image data, and therefore a mismatch between the print image data and the print settings may be effectively prevented.

In addition, the at least one action includes presenting the print setting information selected by the print setting information selector 38 (S430), or setting, in the print job, the print setting information selected by the print setting information selector 38 (S420). According to the above configuration, the print settings corresponding to the print image data are presented or set, and therefore a mismatch between the print image data and the print settings may be effectively prevented.

In addition, the information processing apparatus 2 further includes the pattern information storage 33 that stores a plurality of pieces of pattern information each indicating a plurality of positioning patterns different from each other. The correspondence information associates the plurality of pieces of type information, the plurality of pieces of image shape information, and the plurality of pieces of pattern information with one another. The information processing apparatus 2 further includes a pattern information selector 39 that, by referring to the correspondence information, selects, from the plurality of pieces of pattern information, pattern information corresponding to the type information selected by the type selector 37. The at least one action includes an action based on the pattern information selected by the pattern information selector 39. According to the above configuration, processing is performed in accordance with the pattern information corresponding to the print image data, and therefore a mismatch between the print image data and the positioning pattern may be effectively prevented.

In addition, the at least one action includes presenting the pattern information selected by the pattern information selector 39 (S430) or setting, in the print job, the pattern information selected by the pattern information selector 39 (S420). According to the above configuration, the positioning pattern corresponding to the print image data is presented or set, and therefore a mismatch between the print image data and the positioning pattern may be effectively prevented.

In addition, the information processing apparatus 2 further includes the registration section 35 that acquires the type information and the image shape information and that registers, in the correspondence information, a correspondence relationship between the type information and the image shape information. According to the above configuration, a new correspondence relationship may be registered in the correspondence information.

In addition, when the image shape of the print image data acquired by the print image data receiver 36 does not match any of the image shapes of the plurality of pieces of image shape information stored in the image shape information storage 31 (S230: NO), the type selector 37 may specify image shape information, an image shape of which is most similar to the image shape of the print image data acquired by the print image data receiver 36, among the plurality of pieces of image shape information stored in the image shape information storage 31, and select type information corresponding to the specified image shape information from the plurality of pieces of type information (S270).

In addition, when the image shape of the print image data acquired by the print image data receiver 36 does not match any of the image shapes of the plurality of pieces of image shape information stored in the image shape information storage 31 (S230: NO), the type selector 37 may specify a plurality of pieces of image shape information, image shapes of which are most similar to the image shape of the print image data acquired by the print image data receiver 36, among the plurality of pieces of image shape information stored in the image shape information storage 31, select a plurality of pieces of type information each corresponding to the specified plurality of pieces of image shape information (S280), and select any one of the plurality of pieces of type information based on user input (S290) (S300).

Although preferred embodiments of the present disclosure have been described above, the above embodiments may be modified as described below.

The print image indicated by the print image data typically includes only a print image for one medium. However, instead of this, the print image indicated by the print image data may include print images for six media. In this case, the horizontal and vertical dimensions of the print image including print images for six media are larger than the horizontal and vertical dimensions of the print image including a print image for one medium. Both may be individually registered in the correspondence information.

In the examples described above, the programs may be stored using various types of non-transitory computer readable media and supplied to a computer. The non-transitory computer-readable media include various types of tangible storage media. Examples of the non-transitory computer-readable medium include magnetic recording media (for example, a flexible disk, a magnetic tape, and a hard disk drive) and magneto-optical recording media (for example, a magneto-optical disk). Examples of the non-transitory computer-readable medium further include a compact disc-read-only memory (CD-ROM), a CD-recordable (R), a CD-rewritable (RW), and a semiconductor memory (for example, a mask ROM). Examples of the non-transitory computer-readable medium further include a programmable ROM (PROM)), an erasable PROM (EPROM), a flash ROM, and a random access memory (RAM). In addition, the programs may be supplied to a computer using various types of transitory computer readable media. Examples of the transitory computer-readable medium include electric waves, optical signals, and electromagnetic waves. The transitory computer-readable media may supply programs to a computer via a wired communication channel such as a line or an optical fiber, or via a wireless communication channel.

What is claimed is:

1. An information processing apparatus comprising:
a type information storage storing a plurality of pieces of type information each indicating types of medium different from each other;
an image shape information storage storing a plurality of pieces of image shape information each indicating image shapes different from each other of a print image to be printed on the medium;
a correspondence information storage storing correspondence information associating the plurality of pieces of type information with the plurality of pieces of image shape information;
a print image data acquirer configured to acquire print image data to be set in a print job;
a type selector configured to, by referring to the correspondence information, select, from the plurality of pieces of type information, type information corresponding to the image shape information of the print image data acquired by the print image data acquirer; and
an action executor configured to execute at least one action based on the type information selected by the type selector.

2. The information processing apparatus according to claim 1, wherein
the image shape information indicates horizontal and vertical dimensions of the print image or an aspect ratio of the print image.

3. The information processing apparatus according to claim 1, wherein
the at least one action includes presenting the type information selected by the type selector or setting, in the print job, the type information selected by the type selector.

4. The information processing apparatus according to claim 1, further comprising
a print setting information storage storing a plurality of pieces of print setting information each indicating print settings used for printing on the medium, wherein
the correspondence information associates the plurality of pieces of type information, the plurality of pieces of image shape information, and the plurality of pieces of print setting information with one another; and
a print setting information selector configured to, by referring to the correspondence information, select, from the plurality of pieces of print setting information, print setting information corresponding to the type information selected by the type selector, wherein
the at least one action includes an action based on the print setting information selected by the print setting information selector.

5. The information processing apparatus according to claim 4, wherein
the at least one action includes presenting the print setting information selected by the print setting information selector or setting, in the print job, the print setting information selected by the print setting information selector.

6. The information processing apparatus according to claim 1, further comprising
a pattern information storage storing a plurality of pieces of pattern information each indicating a plurality of positioning patterns different from each other, wherein
the correspondence information associates the plurality of pieces of type information, the plurality of pieces of image shape information, and the plurality of pieces of pattern information with one another; and
a pattern information selector configured to, by referring to the correspondence information, select, from the plurality of pieces of pattern information, pattern information corresponding to the type information selected by the type selector, wherein
the at least one action includes an action based on the pattern information selected by the pattern information selector.

7. The information processing apparatus according to claim 6, wherein
at least one action includes presenting the pattern information selected by the pattern information selector or setting, in the print job, the pattern information selected by the pattern information selector.

8. The information processing apparatus according to claim 1, further comprising a registration section configured to
acquire the type information and the image shape information, and
register, in the correspondence information, a correspondence relationship between the type information and the image shape information.

9. The information processing apparatus according to claim 1, wherein
when an image shape of the print image data acquired by the print image data acquirer does not match any of the image shapes of the plurality of pieces of image shape information stored in the image shape information storage,
the type selector is configured to specify image shape information, an image shape of which is most similar to the image shape of the print image data acquired by the print image data acquirer, among the plurality of pieces of image shape information stored in the image shape information storage, and to select type information corresponding to the specified image shape information from the plurality of pieces of type information.

10. The information processing apparatus according to claim 1, wherein
when an image shape of the print image data acquired by the print image data acquirer does not match any of the image shapes of the plurality of pieces of image shape information stored in the image shape information storage,
the type selector is configured to specify a plurality of pieces of image shape information, image shapes of which are most similar to the image shape of the print image data acquired by the print image data acquirer, among the plurality of pieces of image shape information stored in the image shape information storage, to select a plurality of pieces of type information each corresponding to the specified plurality of pieces of image shape information, and to select any one of the plurality of pieces of type information based on user input.

11. An information processing method executed by a computer, comprising:
storing a plurality of pieces of type information each indicating types of medium different from each other;
storing a plurality of pieces of image shape information each indicating image shapes different from each other of a print image to be printed on the medium;
storing correspondence information associating the plurality of pieces of type information with the plurality of pieces of image shape information;
acquiring print image data to be set in a print job;
selecting, by referring to the correspondence information, from the plurality of type information, type information corresponding to the image shape information of the acquired print image data; and
executing at least one action based on the selected type information.

12. A non-transitory computer-readable storage medium storing a program that causes a computer to function as:
a type information storage storing a plurality of pieces of type information each indicating types of medium different from each other;
an image shape information storage storing a plurality of pieces of image shape information each indicating image shapes different from each other of a print image to be printed on the medium;
a correspondence information storage storing correspondence information associating the plurality of pieces of type information with the plurality of pieces of image shape information;
a print image data acquirer configured to acquire print image data to be set in a print job;
a type selector configured to, by referring to the correspondence information, select, from the plurality of pieces of type information, type information corresponding to the image shape information of the print image data acquired by the print image data acquirer; and
an action executor configured to execute at least one action based on the type information selected by the type selector.
